(19) United States
(12) Patent Application Publication
(10) Pub. No.: US 2014/0151327 A1
(43) Pub. Date: Jun. 5, 2014

(54) PLASMA ETCHING METHOD

(71) Applicant: HITACHI HIGH-TECHNOLOGIES CORPORATION, Tokyo (JP)

(72) Inventors: Satoshi UNE, Shunan-shi (JP); Hiroaki ISHIMURA, Kudamatsu-shi (JP); Kouhei MATSUDA, Kudamatsu-shi (JP)

(73) Assignee: HITACHI HIGH-TECHNOLOGIES CORPORATION, Tokyo (JP)

(21) Appl. No.: 13/761,249

(22) Filed: Feb. 7, 2013

(30) Foreign Application Priority Data
Nov. 30, 2012 (JP) 2012-261847

(51) Int. Cl. B29D 11/00

(52) U.S. Cl. CPC B29D 11/0074
USPC 216/24

(57) ABSTRACT

The present invention provides a plasma etching method with an EUV-exposed resist capable of preventing variations of device feature dimensions. The plasma etching method of the present invention is to plasma-etch a target material with a multilayer resist that serves as a mask and composed of an EUV-exposed resist, an antireflective coating, an inorganic film and an organic film. The plasma etching method includes a first step of depositing a deposition film on a surface of the EUV-exposed resist before the antireflective coating is etched, a second step of etching the deposition film deposited on the antireflective coating and the antireflective coating with a gas mixture of Cl₂ gas, HBr gas and N₂ gas after the first step, a third step of etching the inorganic film after the second step, and a fourth step of etching the organic film after the third step.

### CLAIM OF PRIORITY

The present application claims priority from Japanese patent application JP 2012-261847 filed on Nov. 30, 2012, the content of which is hereby incorporated by reference into this application.

### BACKGROUND OF THE INVENTION

1. Field of the Invention

The present invention relates to plasma etching methods for semiconductor devices. More particularly, the present invention relates to a plasma etching method including formation of a multilayer resist mask.

2. Description of the Related Art

In current semiconductor device fabrication technologies for the 45-nm node and beyond, an immersion lithography system, which includes an ArF laser source to apply ArF laser light to a wafer with purified water introduced between the wafer and a projection lens, is used for mask patterning. To respond to demands for still higher resolution patterning to fabricate 22-nm node semiconductor devices and beyond, next-generation extreme ultraviolet (EUV) lithography technologies using a wavelength of 13.5 nm are being developed.

Resists used in ArF laser lithography are generally thin in thickness and have poor resistance to plasma. Because of this, a multilayer resist mask composed of a resist exposed with ArF laser, an antireflective coating, an inorganic film and a thick bottom resist having high plasma resistance is used to fabricate semiconductor devices. When the multilayer resist mask is formed, etching of the antireflective coating easily introduces dimensional variations. Therefore, plasma etching of the antireflective coating is critical.

As a method for minimizing the dimensional variations after etching of the antireflective coating, Japanese Patent Application Laid-Open Publication No. H11 (1999)-135476 discloses a method including a step of forming an anti-reflective coating (ARC) on a lower layer material, a step of baking the ARC, a step of forming a resist on the ARC, a step of etching the ARC using the resist as a mask with a gas mixture of 30% to 70% O₂ gas and Cl₂ gas, and a step of etching the lower layer material. In addition, Japanese Patent Application Laid-Open Publication No. 2002-289592 discloses that an antireflective coating under openings of a resist is removed by etching with an etching gas containing halogenated hydrocarbons.

It is expected that semiconductor devices soon will be fabricated with a multilayer resist mask composed of an EUV-exposed resist, an antireflective coating, an inorganic film and a highly-plasma-resistant thick bottom resist. Even in this case, etching of the antireflective coating is considered crucial as with the case using the multilayer resist including the ArF resist.

### SUMMARY OF THE INVENTION

However, if the EUV-exposed resist is used to etch the antireflective coating by the method disclosed in Japanese Patent Application Laid-Open Publication No. H11 (1999)-135476, the resist shrinks drastically because the strong reaction of O₂ gas with the resist causes side etching of the resist, and therefore it makes it difficult for the resist to maintain the height necessary to etch the antireflective coating and the rest. This results in shrinkage of device feature dimensions. In addition, the EUV-exposed resist would make this problem more pronounced because the resist is relatively thin.

If the EUV-exposed resist is used to etch the antireflective coating by the method disclosed in Japanese Patent Application Laid-Open Publication No. 2002-289592, the variations of the device feature dimensions caused by the poor plasma-resistance of the EUV-exposed resist can be reduced and the height of the resist can be also maintained; however, variations of the device feature dimensions are still made due to the use of the deposition gas (i.e., the etching gas containing halogenated hydrocarbons).

The present invention provides a plasma etching method that utilizes an EUV-exposed resist, while reducing the feature dimension variations.

The present invention is directed to a plasma etching method for plasma-etching a target material using a multilayer resist, as a mask, including an EUV-exposed resist layer, an antireflective coating, an inorganic film and an organic film. The plasma etching method includes a first step of depositing a deposition film on a surface of the EUV-exposed resist before the antireflective coating is etched, a second step of etching the deposition film on the antireflective coating and the antireflective coating with a gas mixture of Cl₂ gas, HBr gas and N₂ gas after the first step, a third step of etching the inorganic film after the second step, and a fourth step of etching the organic film after the third step.

The present invention is also directed to a plasma etching method for plasma-etching an antireflective coating using a resist as a mask, wherein the antireflective coating is etched with a gas mixture of Cl₂ gas, HBr gas and N₂ gas.

According to the present invention, the plasma etching method using the EUV-exposed resist can reduce the feature dimension variations.

### BRIEF DESCRIPTION OF THE DRAWINGS

Embodiments of the present invention will be described in detail on the following figures, wherein:

FIG. 1 is a schematic cross-sectional view of a plasma etching system according to the present invention;

FIGS. 2A, 2B, 2C and 2D are flow diagrams illustrating the plasma etching method according to the present invention;

FIG. 3 is a graph showing the dependence of etching rates of resist on gases; and

FIG. 4 is a graph showing the dependence of etching rates of resist on ratios of the flow rate of HBr gas to the total flow rate of the gas mixture of Cl₂ gas and HBr gas.

### DESCRIPTION OF THE PREFERRED EMBODIMENTS

With reference to the drawings, an embodiment of the present invention will be described below.

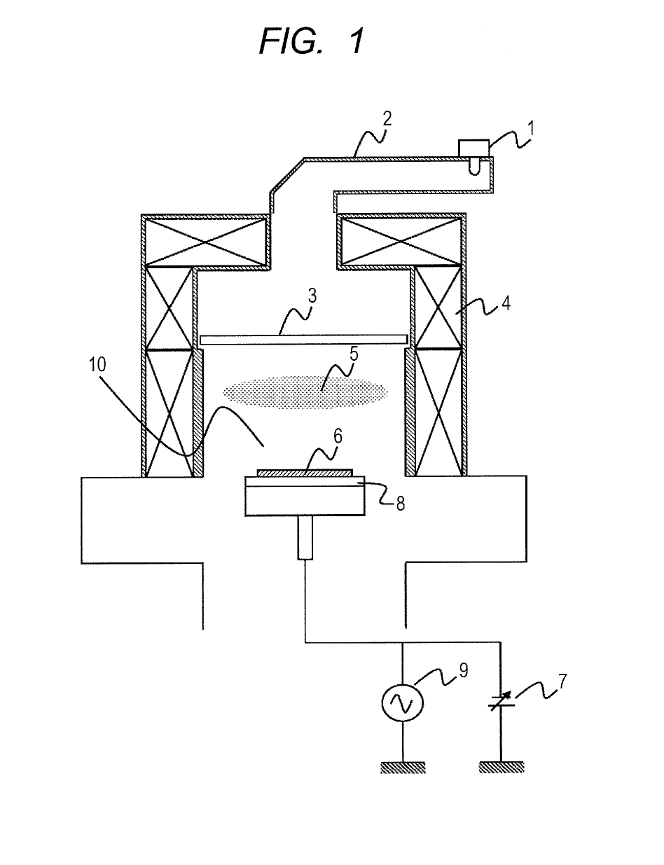

The description starts with a plasma etching system used to implement the present invention. FIG. 1 is a schematic cross-sectional view of an electron cyclotron resonance (ECR) microwave plasma etching system utilizing microwaves and magnetic fields to generate plasma.

Microwaves generated in a magnetron 1 pass through a quartz plate 3 via a waveguide 2 to be transferred to a vacuum chamber 10. The vacuum chamber 10 is surrounded by solenoidal coils 4. A magnetic field generated by the solenoidal coils 4 and the microwaves transferred to the vacuum chamber 10 produce electron cyclotron resonance (hereinafter referred to as ECR). The ECR efficiently converts process gas into high density plasma.

A wafer 6, which is a specimen, is attracted onto a wafer stage 8 by electrostatic attraction force generated by applying DC voltage from an power source for electrostatic chuck 7 to the wafer stage 8. An RF power source 9 supplies radio frequency electric power (hereinafter, referred to as RF bias) to the wafer stage 8 to accelerate ions in plasma 5 and vertically implant ions into the wafer 6.

The internal pressure of a vacuum chamber 10 is adjusted to be a desired level by a turbomolecular pump (not shown) and a dry pump (not shown) that exhaust gas from the vacuum chamber 10 through outlets (not shown) provided thereto.

A description about the present invention implemented with the aforementioned ECR microwave plasma etching system will be described below. First, the cross section structure of the wafer 6 to be plasma-etched according to the present invention will be described.

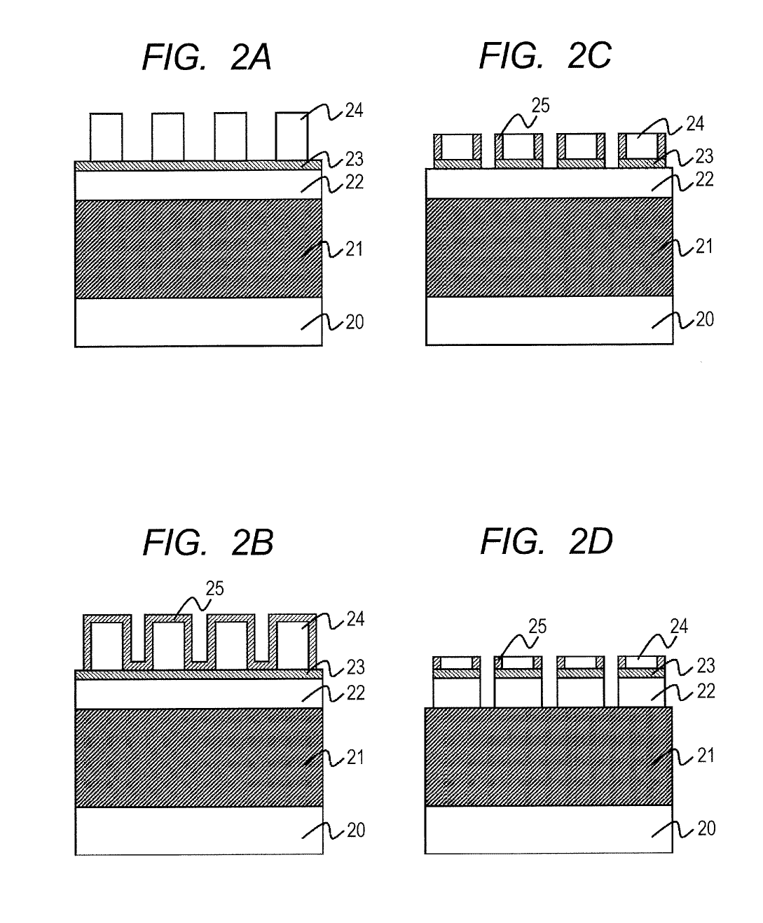

As shown in FIG. 2A, the wafer 6 is a laminate of a target material 20 to be etched, an organic film 21, an inorganic film 22, which is a SiON film of 40 nm in thickness, an antireflective coating 23 of 10 nm in thickness, and a photo resist (PR) 24 of 50 nm in thickness, which has been patterned through EUV exposure in advance, these being stacked in this order from the bottom on a silicon substrate (not shown). The previously formed pattern in this embodiment is a trench pattern.

The organic film 21, inorganic film 22, antireflective coating 23 and resist 24 make up a multilayer resist. The antireflective coating 23 is an organic film, and the organic film 21 is a high plasma-resistant film thicker than the resist 24. The inorganic film 22 may be a SiO₂ film or SiN film.

Next, a description will be made about a process of forming a multilayer resist mask used to etch the target material 20 with plasma. First, a deposition film 25 is deposited on a surface of the resist 24 so as to cover the entire patterned surface of the resist 24, as shown in FIG. 2B, using a gas mixture of CHF₃ gas and Cl₂ gas under etching conditions where process pressure is 0.2 Pa, microwave power is 700 W and RF bias is 10 W. The mixing ratio of the CHF₃ gas and Cl₂ gas is set to 5:1.

The deposition film 25 is made from plasma generated by the gas mixture of CHF₃ gas and Cl₂ gas and therefore is an organic film. The resist 24 that was exposed to EUV has poor resistance to plasma, but the resist 24 covered with the deposition film 25 has improved plasma resistance. In a case where the deposition film is deposited on the surface of the resist 24 with fluorocarbon gas to improve the plasma resistance of the resist 24, the line width roughness (LWR) deteriorates; however, the deposition film of the present invention that is deposited with the gas mixture containing Cl₂ gas can prevent deterioration of LWR.

One reason that Cl₂ gas can prevent LWR deterioration is possibly that the surface of the deposition film 25 is etched with Cl₂ gas and the surface-etched deposition film 25 is deposited on the surface of the resist 24.

The mixing ratio of CHF₃ gas and Cl₂ gas is set to 5:1 in this embodiment; however, the ratio of the Cl₂-gas flow rate to be added to the CHF₃-gas flow rate can be 5% to 20%. If the ratio of the Cl₂-gas flow rate to be added is less than 5%, too much deposition film 25 is deposited, which deteriorates the LWR. On the other hand, if the ratio of the Cl₂-gas flow rate to be added exceeds 20%, the deposition film 25 is not deposited in a sufficient amount on the pattern of the resist 24 and therefore the resist 24 as a mask at an initial stage cannot be sufficiently thick.

Next, the deposition film 25 deposited on the antireflective coating 23 and the antireflective coating 23 are removed, as shown in FIG. 2C, using a gas mixture of Cl₂ gas, HBr gas and N₂ gas under etching conditions where process pressure is 0.2 Pa, microwave power is 800 W and RF bias is 40 W. The mixing ratio of the Cl₂ gas and HBr gas is set to 5:3. Although the deposition film 25 deposited on the upper surfaces of the antireflective coating 23 and resist 24 is removed as shown in FIG. 2C, the deposition film 25 deposited on the side walls of the resist 24 is mostly left.

The deposition film 25 left on the side walls of the resist 24 can reduce plasma damage to the resist and also can prevent the LWR deterioration after the antireflective coating 23 is etched. This is probably achieved for the following reasons.

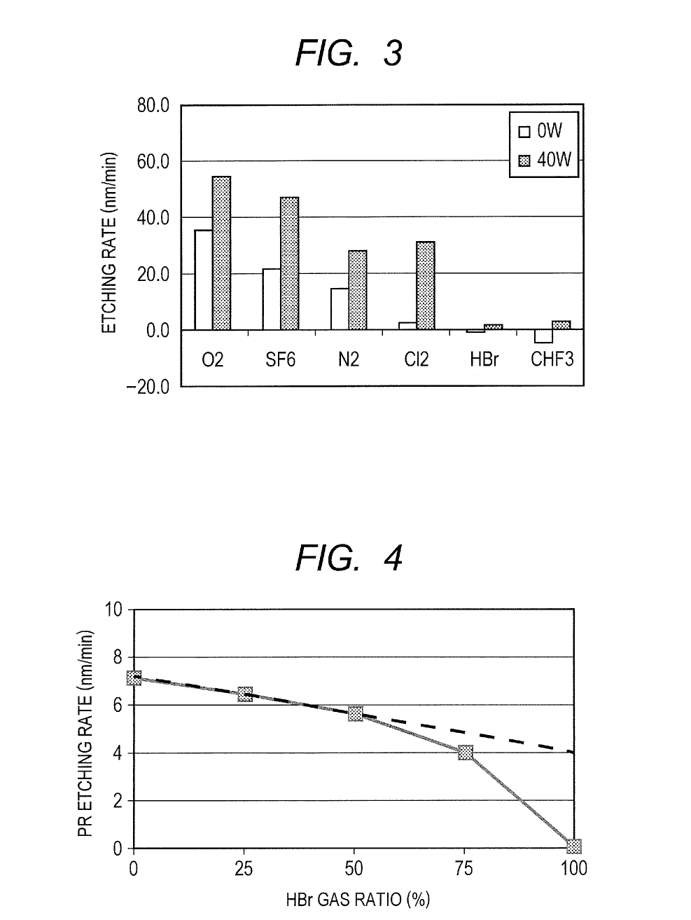

FIG. 3 shows etching rates of the resist etched at an RF bias of 0 W or 40 W with O₂ gas, SF₆ gas, N₂ gas, Cl₂ gas, HBr gas and CHF₃ gas. The gases demonstrating the higher ratios of the etching rate at 40 W RF bias to the etching rate at 0 W RF bias are usable to perform anisotropic etching with less side etching. As shown in FIG. 3, the gas having the highest ratio, approximately 12, of the etching rate at 40 W RF bias to the etching rate at 0 W RF bias is Cl₂ gas.

In terms of HBr gas and CHF₃ gas, FIG. 3 shows that the deposition film is deposited when the RF bias is 0 W. FIG. 3 also shows a result that CHF₃ gas tends to more easily form the deposition film than HBr gas. This tendency may result in excessive formation of the deposition film and therefore in deterioration of the LWR. Consequently, an appropriate deposition gas for reducing side etching is considered to be HBr gas.

As shown in FIG. 3, O₂ gas, SF₆ gas and N₂ gas have higher etching rates, respectively, than Cl₂ gas at 0 W RF bias, and therefore it is considered that these gases can contribute to improvement of etching rate when a low RF bias is applied. However, O₂ gas and SF₆ gas having the high etching rate at 0 W RF bias easily cause side etching. In view of the circumstances, an appropriate gas that causes less side etching and contributes to improvement of the etching rate is considered to be N₂ gas.

As described above, the gas mixture of Cl₂ gas, HBr gas and N₂ gas used to etch the antireflective coating brings etching and deposition in balance and therefore can maintain the dimension of the resist and prevent LWR deterioration.

Even after the antireflective coating 23 is etched with the gas mixture of Cl₂ gas, HBr gas and N₂ gas, the resist 24 maintains its height enough to etch the underlying layers of the antireflective coating 23. This is probably because the deposition film 25, which is formed on the surface of the resist 24 before the antireflective coating 23 is etched, is deposited thicker on the resist 24 than on the surface of the antireflective coating 23.

The reason why the deposition film 25 becomes thicker on the resist 24 than on the surface of the antireflective coating 23 before etching of the antireflective coating 23 is probably that materials having a high sticking coefficient generally easily stick to a closer object than a further object, thereby making the deposition film 25, which is deposited on the surface of the resist 24 before etching of the antireflective coating 23, thicker on the resist 24 than on the surface of the antireflective coating 23.

In this embodiment, the mixing ratio between Cl₂ gas and HBr gas is set to 5:3; however, the ratio of the flow rate of HBr gas to the total flow rate of the gas mixture of Cl₂ gas and HBr gas can be higher than 0%, but equal to 50% or lower. The ratio is determined for the following reasons.

As shown in FIG. 4, when the ratio of the flow rate of HBr gas to the total flow rate of the gas mixture of Cl₂ gas and HBr gas is from 0% to 50%, the etching rate of the resist decreases at a constant rate, but steeply drops when the ratio exceeds 50%. This result proves that adjusting the ratio of the flow rate of HBr gas to the total flow rate of the gas mixture of Cl₂ gas and HBr gas to be higher than 0% to 50% can prevent significant reduction in etching rate of the antireflective coating 23 and therefore can prevent LWR deterioration.

Furthermore, adjusting the flow rate of HBr gas with respect to the total flow rate of the gas mixture of Cl₂ gas and HBr gas within a range from higher than 0% to 50% can control the dimensions after etching of the antireflective coating 23. For example, decreasing the ratio of the flow rate of HBr gas to the total flow rate of the gas mixture of Cl₂ gas and HBr gas makes smaller dimensions, while increasing the ratio of the flow rate of HBr gas to the total flow rate of the gas mixture of Cl₂ gas and HBr gas makes larger dimensions.

Then, after the antireflective coating 23 is etched with the gas mixture of Cl₂ gas, HBr gas and N₂ gas, the inorganic film 22 is removed, as shown in FIG. 2D, using a gas mixture of CHF₃ gas and SF₆ gas under etching conditions where process pressure is 0.8 Pa, microwave power is 800 W, and RF bias is 40 W. The SF₆ gas is added to the CHF₃ gas at an additive rate of 10%. Etching the inorganic film 22 with the gas mixture of the CHF₃ gas and SF₆ gas under the aforementioned etching conditions can prevent LWR deterioration and dimensional variations caused by absence of the resist 24 as a mask.

After the inorganic film 22 is etched with the gas mixture of CHF₃ gas and SF₆ gas, etching the organic film 21 with a gas mixture of N₂ gas and H₂ gas can form a multilayer resist mask of a desired size while preventing LWR deterioration. Further etching of the target material 20 with the multilayer resist as a mask enables formation of lines without breaks caused by absence of the mask, while preventing LWR deterioration.

The present embodiment uses the gas mixture of CHF₃ gas and SF₆ gas to etch the inorganic film 22 and the gas mixture of N₂ gas and H₂ gas to etch the organic film 21 as an example; however, the present invention is not limited by the kinds of gases for etching the inorganic film 22 and organic film 21. Also the present invention is not limited by the kinds of gases for etching the target material 20.

As described above, the plasma etching method using the EUV-exposed resist according to the present invention can prevent variations of the device feature dimensions. In addition, the present embodiment takes advantage of the similarity in ingredients between the deposition film 25 and the antireflective coating 23 to remove the deposition film 25 and antireflective coating 23 under the same etching conditions, thereby omitting the step of removing the deposition film 25 in the present invention.

Although an ECR (Electron Cyclotron Resonance) microwave plasma etching apparatus utilizing microwaves and magnetic fields is used in this embodiment as an example of plasma generation means, the present invention can achieve the same effect as the above embodiment even if the present invention is applied to a helicon-wave plasma etching system, an inductively coupled plasma etching system, a capacitively coupled plasma etching system, and other types of plasma etching systems.

In addition, this embodiment was described with a trench pattern as an example; however, the present invention is not limited by the trench pattern and applicable to a hole pattern.

Furthermore, this embodiment uses the EUV-exposed resist as an example; however, the present invention is not limited to the EUV-exposed resist to perform the method for etching the antireflective coating with a gas mixture of Cl₂ gas, HBr gas and N₂ gas. Even if the present invention is applied to the method for etching the antireflective coating with a gas mixture of Cl₂ gas, HBr gas and N₂ gas with an ArF laser-exposed resist as a mask, the same effect as the aforementioned embodiment can be achieved.

What is claimed is:

1. A plasma etching method for plasma-etching a target material using a multilayer resist as a mask, the multilayer resist including an EUV-exposed resist, an antireflective coating, an inorganic film and an organic film, the plasma etching method comprising:
a first step of depositing a deposition film on a surface of the EUV-exposed resist before the antireflective coating is etched;
a second step of etching the deposition film on the antireflective coating and the antireflective coating with a gas mixture of Cl₂ gas, HBr gas and N₂ gas after the first step;
a third step of etching the inorganic film after the second step; and
a fourth step of etching the organic film after the third step.

2. The plasma etching method according to claim 1, wherein
a gas mixture of CHF₃ gas and Cl₂ gas is used in the first step.

3. The plasma etching method according to claim 2, wherein
the ratio of the flow rate of the HBr gas to the total flow rate of the gas mixture of Cl₂ gas and HBr gas is set to higher than 0%, but equal to 50% or lower.

4. The plasma etching method according to claim 2, wherein
the inorganic film is a SiON film, and
a gas mixture of CHF₃ gas and SF₆ gas is used in the third step.

5. A plasma etching method for plasma-etching an antireflective coating using a resist as a mask, wherein
the antireflective coating is etched with a gas mixture of Cl₂ gas, HBr gas and N₂ gas.
